(19) United States
(12) Patent Application Publication
(10) Pub. No.: US 2016/0305494 A1
(43) Pub. Date: Oct. 20, 2016

(54) ACTUATOR THAT LOCKS IN A MAXIMUM POSITION FOR ACTUATING A HYDRAULIC CLUTCH ACTUATOR, AND CLUTCH SYSTEM THAT CAN BE ELECTRICALLY ACTUATED

(71) Applicant: ROBERT BOSCH GMBH, Stuttgart (DE)

(72) Inventors: Oliver Gerundt, Friolzheim (DE); Armin Stubner, Buehl-Altschweier (DE); Hans-Peter Dommsch, Lichtenau (DE); Stefan Demont, Buehl (DE); Markus Feigl, Markgroeningen (DE); Jihad Bsul, Eggenstein-Leopoldshafen (DE); Lucas Durix, Drusenheim (FR); Fengmei Cheng, Karlsruhe (DE); lngo Drewe, Buehl (DE); Jean-Luc Augier, Asperg (DE); Norbert Martin, Achern (DE); Michael Koerner, Bonn (DE)

(21) Appl. No.: 15/101,996

(22) PCT Filed: Oct. 29, 2014
(86) PCT No.: PCT/EP2014/073253

§ 371 Date: Jun. 6, 2016

(30) Foreign Application Priority Data
Dec. 5, 2013 (DE) 10 2013 225 009.6

(51) Int. Cl. F16D 28/00; F16D 25/12; F16H 25/18; F16D 23/12

(52) U.S. Cl. CPC F16D 28/00; F16D 23/12; F16D 25/12; F16H 25/18; F16D 2023/123

(57) ABSTRACT

The invention relates to an actuator (13) for actuating a piston (17) of a hydraulic clutch actuator and how said el actuator (13) can be used in a hydraulic system of an electrically actuatable clutch system for a motor vehicle. An electric motor (11) drives an actuating disc (55). A slotted guide structure (31) is arranged on the actuating disc (55). The slotted guide structure (31) forms a contact surface (33), the radius (r) of which increases in relation to an axis (65) from a minimum radius point (35) to a maximum radius point (37). An actuating rod (41) is engaged with a piston (17) of the clutch actuator and is supported on the first slotted guide structure (31) and guided in such a way that, with one rotation of the actuating disc (55), a pressure is exerted on the actuating rod (41) by the first slotted guide structure (31). A holding structure (31) is provided on the slotted guide structure, for example in the form of a recess (40), said holding structure being designed in such a way that, as a result of an effect of the holding structure (40), the actuating rod (41) maintains a position

### BACKGROUND OF THE INVENTION

The present invention relates to an actuator for actuating a hydraulic clutch actuator as well as to an electrically actuatable clutch system equipped with such an actuator.

In motor vehicles, clutches are traditionally used to temporarily interrupt a power flow between a motor and a drive train coupled to the wheels of the motor vehicle.

As a further development, particularly for clutch systems that are actuated by the driver, electrically actuatable clutches are currently being developed for modern motor vehicles. In these clutch systems, a clutch pedal is no longer directly mechanically connected to the hydraulics. Instead a sensor, for example, detects a current pedal position and subsequently sends a corresponding signal to a control device. On the basis of this signal, the control device actuates an electrohydraulic actuator, which moves a piston in a master cylinder of the hydraulic system of the clutch system mostly by means of a rotational movement of an electric motor.

Such actuators can, for example, be implemented in such a way that an electrically driven spindle nut moves a spindle, which in turn presses on a hydraulic piston.

In clutches closed in the normal state, clutch springs generally provide the necessary force on the clutch discs for closing the clutch. In the case of conventional clutches which are to be directly mechanically actuated by the driver, the characteristics or, respectively, characteristic curve of such clutch springs define the force behavior of the clutch which is transmitted from the clutch via the hydraulics to the clutch pedal and thus is haptically detected by the driver. The clutch springs typically do not have a linear force characteristic curve but an S-shaped characteristic curve. When actuating a clutch, there is generally the desire or request to be able to proceed quickly with little force in the first portion of the characteristic curve, i.e. when initially depressing the clutch pedal, and to proceed in the second portion of said characteristic curve with a substantially greater force, i.e. the spring is strongly tensioned, and with a higher degree of accuracy.

Linear systems, such as the spindle nut actuator mentioned above, are not able to meet such demands.

Additional functionalities are furthermore being developed for modern motor vehicles in order, for example, to reduce fuel consumption or to increase driving comfort. Hence, a so-called “coasting” functionality is currently being developed in which the vehicle is allowed to freely roll in suitable driving situations by a force closure being temporarily interrupted between the wheels and the drive unit of the vehicle by means of automatically actuating the clutch. During such a coasting operation, the clutch is, if applicable, kept open for longer periods of time.

### SUMMARY OF THE INVENTION

Embodiments of the present invention render an actuator possible for actuating a hydraulic clutch actuator, which, on the one hand, can produce a suitable force characteristic curve for actuating a clutch and which, on the other hand, is simply constructed and can operate reliably. In combination with the actuator, the hydraulic clutch actuator can particularly be operated in certain operating situations in such a way that said clutch actuator can be held in a position in which the clutch is open, i.e. can be locked in place without the actuator having to be permanently supplied with substantial power for this purpose.

A first aspect of the present invention relates to an actuator for actuating a hydraulic clutch actuator, said actuator comprising an electric motor, an actuating disc that is rotatably driven about an axis by the electric motor, a slotted guide structure coupled to the actuating disc and an actuating rod. The slotted guide structure forms a contact surface, the radius of which, in relation to the axis about which the actuating disc rotates, continuously increases from a minimum radius point in an actuating direction of rotation about the axis to a maximum radius point. The actuating rod is engaged at one end thereof with the clutch actuator, i.e., for example, with a piston of a master cylinder. In so doing, the actuating rod is guided and supported on the slotted guide structure in such a way that, with one rotation of the actuating disc in the actuating direction of rotation of the slotted guide structure, a pressure is exerted on the actuating rod. The actuator is thereby characterized in that a holding structure is provided on the slotted guide structure near the maximum radius point, said holding structure being designed in such a way that, as a result of an effect of the holding structure, the actuating rod maintains a position substantially maximally disengaged in relation to the clutch actuator. Ideas relating to the embodiment of the present invention can inter alia be considered to be based on the concepts and insights subsequently described:

As noted above with regard to electrically actuatable clutch systems, actuators which linearly generate actuating forces, such as, e.g., spindle nut actuators, generally do not meet the requirements of force characteristic curves for actuating the clutch. One approach to solving the problem is to provide an actuator with a type of slotted guide disc, wherein a contact surface describes a curved path that is not circular about a center of rotation but helical. In the case of such a helically designed contact surface of a slotted guide structure, the radius, i.e. the distance between the contact surface and the center of rotation, increases as a function of the angle of rotation. The curvature or, respectively, the curve of the slotted guide structure can thereby be adapted to the characteristic curve of the clutch and the resulting demands.

The helical slotted guide structure can be arranged on the actuating disc driven by the electric motor or at least mechanically coupled to the same; thus enabling said slotted guide structure to also rotate when the actuating disc is rotated about the axis thereof by the electric motor. In the process, an end of the actuating rods is supported on the contact surface formed by the slotted guide structure. Because the radius of the slotted guide structure varies, the actuating rod can be displaced by rotating the actuating disc and thus rotating the slotted guide structure.

The actuating rod, which, on the other end thereof, is coupled to the hydraulic clutch actuator, which in turn is connected via the hydraulics to the spring-preloaded clutch, is normally pressed with a suitable elastic pre-tensioning force against the contact surface of the slotted guide structure. On account of such a force acting on the contact surface and the feature that the radius of the contact surface decreases in a direction towards a minimum radius point, a restoring torque acts on the actuating disc connected to the slotted guide structure. This torque attempts to displace the actuating disc to a position in which the clutch is not actuated by the actuating rod. If the clutch is to be actuated, said torque has to be overcompensated by means of the electric motor acting on the actuating disc, in order to move said actuating disc into a position in which the actuating rod actuates the clutch.

In order to hold the clutch in an actuated state for longer periods of time, for example in the coasting mode, the electric motor driving the actuating disc in the case of conventional actuators must permanently work against the restoring torque acting on the actuating disc and thus must be constantly supplied with power.

According to the invention, provision is therefore made for a holding structure to be provided on the slotted guide structure in the proximity of the maximum radius point of the contact surface. This holding structure is to be designed in such a way that, as a result of an effect of said holding structure, the actuating rod locks into a substantially maximally disengaged position. In other words, the holding structure is designed in such a way that the actuating rod is held in a position in which said actuating rod actuates the clutch and interacts with the actuating disc such that it does not exert a restoring torque on the actuating disc. Because a restoring torque does not then have to be overcompensated by the electric motor in the engaged state, said electric motor does not have to be supplied with power if the clutch is to remain actuated for an extended period of time, for example during a coasting mode.

According to one embodiment, the actuating rod is elastically preloaded in the direction of the slotted guide structure and the slotted guide structure is designed in such a way that a force, as a result of an effect of the holding structure, is exerted by the actuating rod on the actuating disc in such a way that, in order to rotate the actuating disc against the actuating direction of rotation, a force has to be exerted at least temporarily by the electric motor on the actuating disc in the direction opposite the actuating direction of rotation. In other words, the actuator, if the actuating rod is locked in the disengaged position, is situated in a type of metastable state, from which it can only be moved out of again by a force being exerted on the actuating disc that is opposite the actuating direction of rotation.

According to one embodiment, the holding structure is configured as a local recess in the contact surface of the slotted guide structure in the proximity of the maximum radius point. In other words, the radius of the contact surface does not increase to the same extent, i.e. with the same slope, from the minimum radius point up to the maximum radius point and the contact surface then ends; but the slope decreases locally in the proximity of the maximum radius point or even becomes negative. In this way, a recess or depression is formed locally in the contact surface. The actuating rod which is supported on the contact surface and is elastically preloaded against the same can engage in this recess. In such an engaged state, the actuating rod still in fact presses against the contact surface, the resulting force can, however, no longer produce the effect that the actuating disc moves. Instead the actuating disc remains in this engaged position as long as a torque is not exerted by the electric motor on said actuating disc.

According to a special modification to the embodiment previously described, the recess is designed in such a way that the radius (r) decreases from a point at the beginning of the recess in the actuating direction of rotation about the axis to a point in the center of the recess. In other words, the radius of the contact surface continuously increases from the minimum radius point in the actuating direction of rotation up until the beginning of the recess. The radius then however, at least temporarily, decreases further in the actuating direction of rotation and can subsequently increase again, whereby the recess is formed in the contact surface, which can act as a holding structure so that the actuating rod can lock into the maximally disengaged position.

The holding structure can alternatively be designed as a region having a constant radius, in which particularly the actuating rod is not displaced in the axial direction beyond the maximum radius point during a further rotation of the actuating disc.

In a further embodiment, the holding structure is designed as a planar, straight surface of the slotted guide structure, in particular as a peripheral surface of the actuating disc, wherein the actuating rod, with a further rotation of the actuating disc, is displaced beyond the maximum radius point in an axial direction in relation to the axis.

According to one embodiment, the actuating rod is supported on the slotted guide structure by means of a bearing mounted to said actuating rod. The bearing with which the actuating rod is supported on the slotted guide structure does not have to be in direct mechanical contact with the slotted guide structure; but rather provision can be made, e.g., for a roller to be supported on the bearing, via which roller the bearing can be supported on the slotted guide structure and which can roll along the contact surface of the slotted guide structure.

According to one embodiment, a spindle can be disposed on a shaft of the electric motor and the actuating disc can be designed as a worm wheel, the teeth of which are engaged with the spindle. In this concrete embodiment, the actuating disc designed as a worm wheel can be driven by the electric motor with the aid of the spindle provided on the shaft thereof, similar to a worm drive. In this case, an angular speed of the actuating disc is linearly dependent on a rotational speed of the electric motor. A force which is exerted by the slotted guide structure coupled to the actuating disc onto the actuating rod is however not linearly dependent on the rotational speed of the electric motor due to the worm-like form of the slotted guide structure.

According to one embodiment of the invention, the actuating disc and the slotted guide structure are designed as one piece. In other words, the slotted guide structure can be integrally formed directly on the actuating disc. The joint component can, for example, be produced as an injection molded part.

According to one embodiment, the shaft of the electric motor and the actuating rod are disposed at an oblique angle to each other. The actuating rod can, for example, be disposed in such a way that said rod, from a position at which it is in contact with the first slotted guide structure with the one end thereof, is disposed obliquely to the shaft of the electric motor and therefore obliquely back towards the electric motor with the opposite end thereof. The clutch actuator disposed at the second end of the actuating rod can therefore be disposed right beside the electric motor; thus enabling a total installation size of the actuator including the clutch actuator to be minimized.

An electrically actuatable clutch system which includes an actuator according to one embodiment of the invention can, on the one hand, effect a desired non-linear force behavior when actuating the clutch. On the other hand, the actuator or, respectively, the actuating rod provided thereon can be locked in a substantially maximally disengaged state; thus enabling the clutch to be actuated for longer periods of time without the electric motor having to be constantly supplied with power.

It should be noted that possible features and advantages of the embodiments of the invention are described here while referencing different embodiments of the invention. A person skilled in the art recognizes that the features can be exchanged or combined in a suitable manner in order to arrive at further embodiments of the invention.

### BRIEF DESCRIPTION OF THE DRAWINGS

Embodiments of the invention are described below with reference to the attached drawings, wherein neither the drawings nor the description are to be interpreted in a manner which limits the scope of the invention. In the drawings:

FIG. 1 shows schematically an electrically actuatable clutch system;

FIG. 2 shows a perspective view of an actuator according to one embodiment of the present invention;

FIG. 3 shows a perspective view of an actuator according to a further embodiment of the present invention;

FIG. 4 shows a perspective view of an actuator according to still another embodiment of the present invention.

The figures are only schematically depicted and are not depicted true to scale. Identical reference signs designate identical or identically operating features in the different drawings.

### DETAILED DESCRIPTION

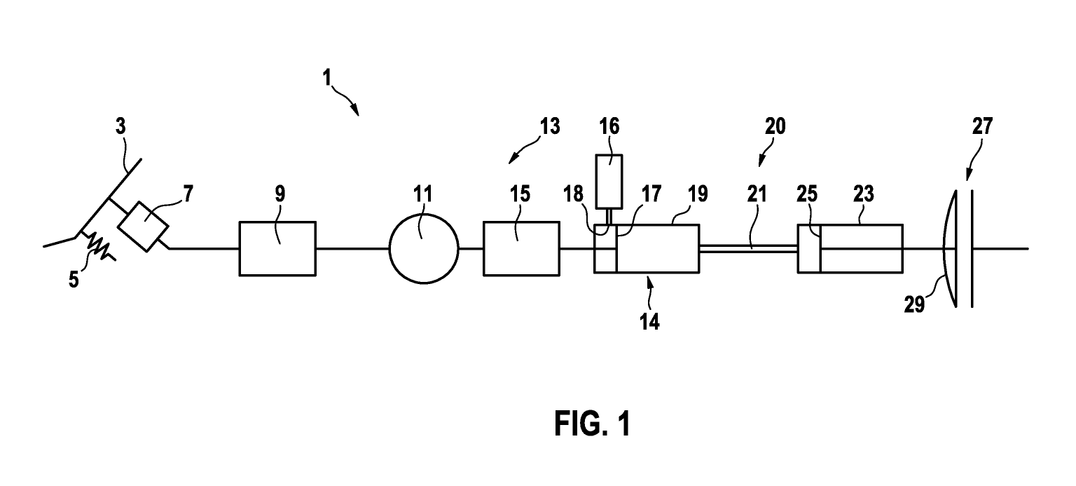

FIG. 1 shows an electrically actuatable clutch system 1 for a motor vehicle. A foot pedal 3 can be pressed by a driver down against a spring 5. In so doing, a current position of the foot pedal 3 is detected with the aid of a sensor 7 and transmitted to a control device 9. On the basis of the signals of the sensor 7, the control device 9 activates an electric motor 11 of an actuator or actuation device 13 in order to move a piston 17 within a master cylinder 19, which forms a part of a clutch actuator 14, via a suitable force transmission device 15, for example in the form of a gear unit. In this way, hydraulic oil can be pressed through a line 21 into a slave cylinder 23. A piston 25 in the slave cylinder 23 is mechanically connected to the clutch 27 and can disengage the same while being actuated by the slave cylinder 23. A return spring 29 provided on the clutch 27 ensures that a counter pressure is exerted on the slave cylinder 23 so that, as the actuation of the foot pedal 3 decreases and the actuator 13 is correspondingly activated, the clutch 27 is again engaged. A balancing bore 18 is provided in a rear region of the master cylinder 19 that forms the clutch actuator 14. If the piston 17 is moved far enough to the rear beyond said balancing bore 18, hydraulic oil can flow from a reservoir 16 into the interior of the master cylinder 19.

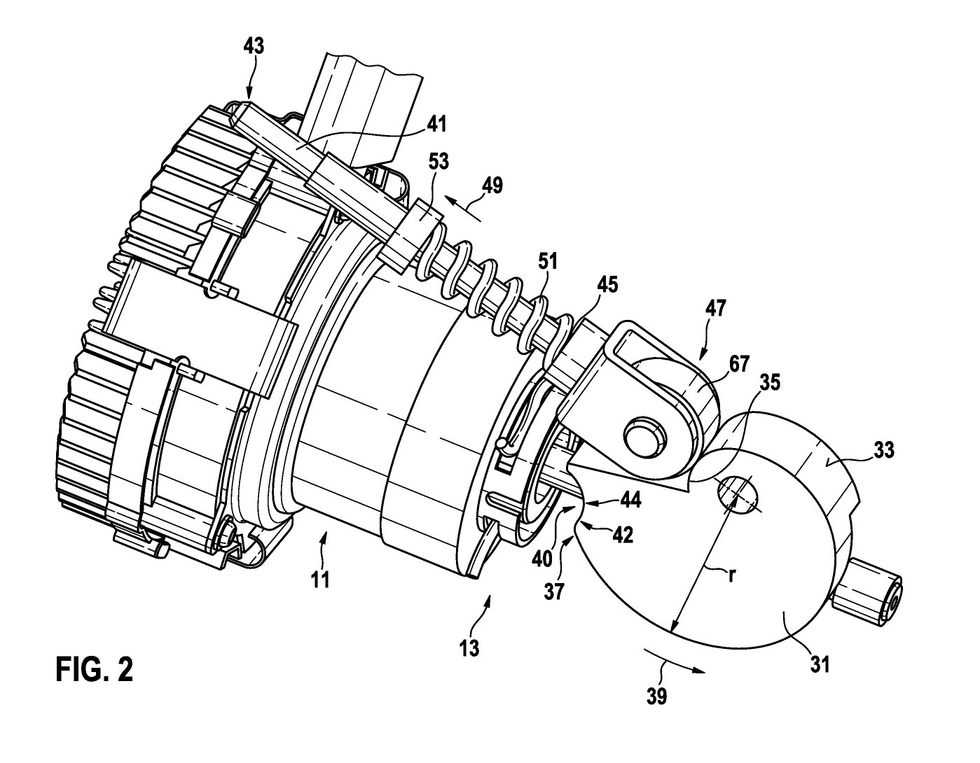

FIG. 2 shows a perspective view of an actuator 13 in which an electric motor 11 rotationally drives an actuating disc (not visible in FIG. 2 due to the perspective) having a slotted guide structure 31 arranged thereon. In the example depicted, the slotted guide structure 31 forms a contact surface 33 on the lateral surface thereof, the radius r of which contact surface continuously increases from a minimum radius point 35 to a maximum radius point 37 if the actuating disc coupled to the slotted guide structure rotates said slotted guide structure 31 in an actuating direction of rotation 39. An actuating rod 41 is coupled at the one end 43 thereof to a hydraulic clutch actuator (not depicted in FIG. 2). At the other end 45 thereof, the actuating rod 41 is supported by means of a bearing 47 mounted thereon on the contact surface 31 of the slotted guide structure 31. If the slotted guide structure 31 is rotated in the actuating direction of rotation 39, the contact surface 31 presses the actuating rod 41 continuously in the direction 49 of the hydraulic clutch actuator due to the increasing radius r. As a result, a clutch coupled at the other end to the clutch actuator is actuated, i.e. the clutch discs are disengaged and thus separated from one another. A spring which preloads the clutch discs towards one another effects thereby a restoring force on the clutch actuator so that the actuating rod 41 is pressed towards the contact surface 33. In the embodiment depicted in FIG. 2, the actuating rod 41 is additionally preloaded by an additional spring 51, which is supported on a bearing 53, oppositely to the direction 49, i.e. away from the clutch actuator, and is thus pressed against the contact surface 33.

The contact surface 33 has a local recess 40 in close proximity to the maximum radius point 37. The radius r of the contact surface 33 decreases somewhat locally at the beginning 42 of this recess 40, i.e. directly behind the maximum radius point 37, until said radius increases again starting at a center 44 of the recess 40. If the slotted guide structure 31 is therefore further rotated in the actuating direction of rotation 39 beyond the maximum radius point 37, the roller 67 of the bearing 47 of the actuating rod 41, which roller rolls along the contact surface 33, comes into engagement with the recess 40 so that the actuating rod effectively locks in place. In this locked-in-place state, the actuating rod is almost maximally disengaged so that the clutch is actuated. The locked-in-place state is metastable, i.e. the slotted guide structure 31 is not rotated but remains in the position thereof due to the restoring force which is transmitted by the actuating rod 41 and which acts oppositely to the actuating direction 49. Hence, the actuating rod 41 also remains in the disengaged position thereof without the electric motor having to permanently produce a torque.

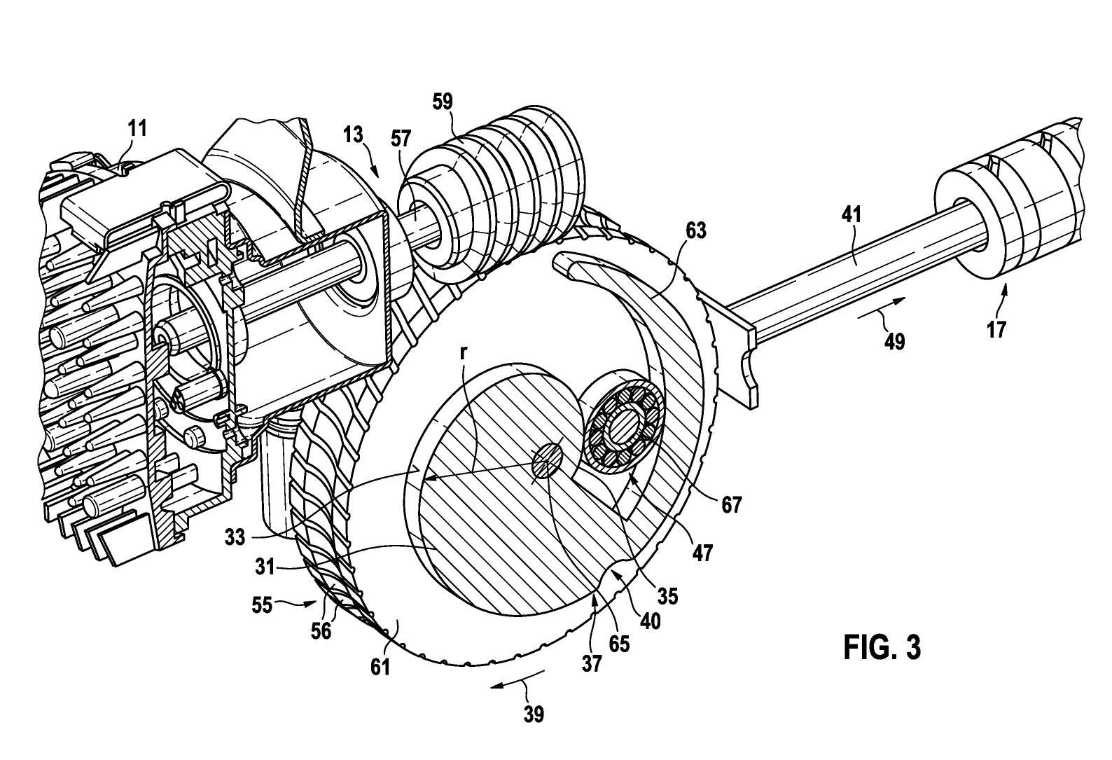

A perspective view of a further embodiment of an actuator 13 according to the invention is depicted in FIG. 3. In this case, an electric motor 11 drives a spindle 59 via a shaft 57. The spindle 59 is engaged with teeth 56 of an actuating disc 55, which in this case is designed as a worm gear 61. The electric motor 11 can thus move the actuating disc 55 in or against an actuating direction of rotation 39.

Slotted guide structures 31 are formed in each case on both end faces of the actuating disc 55. Each of said guide structures 31 forms a contact surface 33, the radius r of which, in relation to an axis 65 of the actuating disc 55, continuously increases in the actuating direction of rotation 39 up to a point 37.

If the actuating disc 55 is correspondingly rotated by the motor 11, the bearings 47 connected to the actuating rod 41 roll via rollers 67 along the contact surface 33. Due to the increasing radius r of the contact surface 33, a pressure is thereby exerted on the actuating rod 41, and said actuating rod 41 is gradually displaced in the direction 49 of the piston 17. A hydraulic pressure which is thus brought about by a piston 17 can accordingly allow a clutch 27 to disengage, i.e. to decouple.

In order to subsequently reengage the clutch 27, the actuator 13 is operated in the opposite direction. While the motor 11 rotates the actuating disc 55, the rollers 67 of the bearings 47 are then permanently pressed against the contact surface 33 of the first slotted guide structure 31 because a restoring force is exerted by the return spring 29 of the clutch 27 onto the actuating rod 41 coupled to the bearings 47.

A recess 40 is in turn provided in every contact surface 33. If the actuator is actuated up to the maximum position thereof, the rollers 67 of the bearing 47 engage and prevent the actuating rod 41 from spontaneously moving backwards by said actuating rod rotating the actuating disc 55 backwards by means of the return force transferred by said rod onto the contact surface 33. Only if the motor 11 actively rotates the actuating disc 55 against the actuating direction 39, until the rollers 67 have moved out of the recesses 40, can the actuating disc 55 again rotate back against the actuating direction of rotation 39 with or without support by means of the motor 11.

In the embodiment depicted in FIG. 3, the actuating rod 41 extends substantially parallel to the shaft 57 of the electric motor 11.

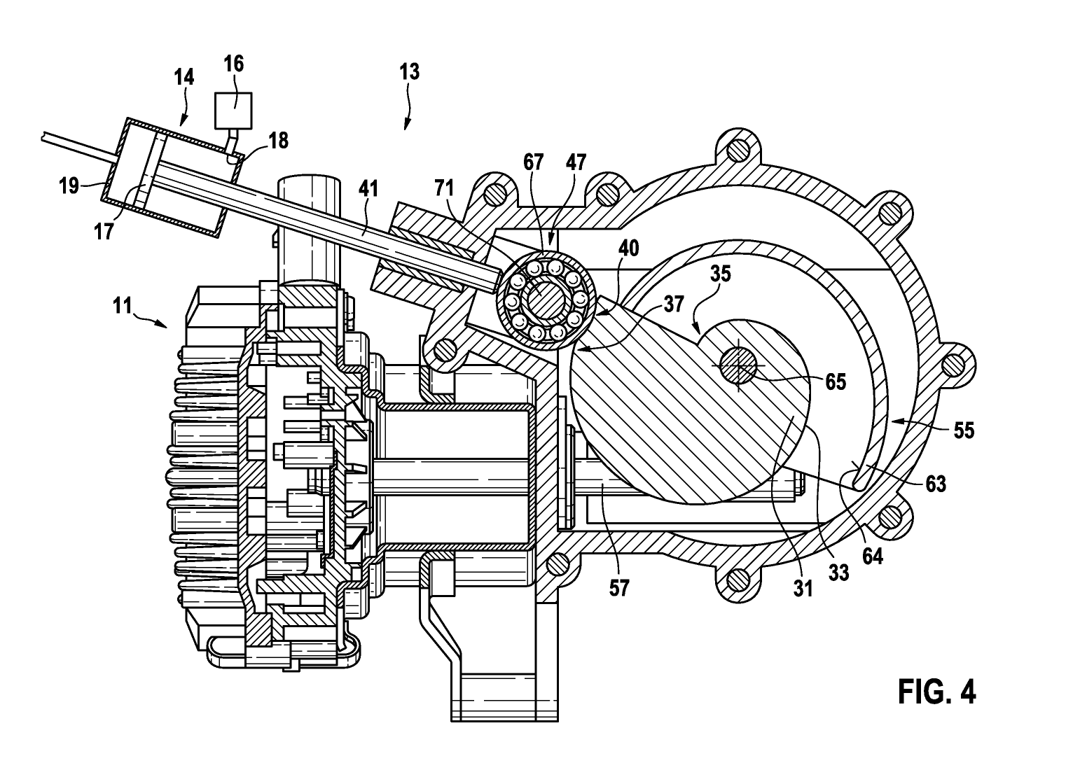

In an alternative configuration, as is depicted in the perspective view of FIG. 4, the actuating rod 41 is in contrast disposed at an oblique angle in relation to the shaft 57 of the electric motor 11. The clutch actuatorl4 can therefore be disposed next to the electric motor 11, whereby the entire installation space can be reduced for the clutch system 1.

Apart from the disposal of the actuating rod 41, the structures and modes of action of the components of the actuator 13 depicted in FIG. 4 are largely similar to those in the system depicted in FIG. 3.

1. An actuation device (13) for actuating a hydraulic clutch actuator (14), comprising:
an electric motor (11),
an actuating disc (55) rotatably driven by the electric motor (11) about an axis (65),
a slotted guide structure (31) coupled to the actuating disc (55), and an actuating rod (41),
wherein the slotted guide structure (31) forms a contact surface (33), a radius (r) of which increases in relation to the axis (65) from a minimum radius point (35) in an actuating direction of rotation (39) about the axis (65) to a maximum radius point (37), wherein the actuating rod (41) is engaged at one end (43) thereof with the clutch actuator (14),
wherein the actuating rod (41) is supported on the slotted guide structure (31) and guided in such a way that, with one rotation of the actuating disc (55) in the actuating direction of rotation (39) of the slotted guide structure (31), a pressure is exerted on the actuating rod (41), and
wherein a holding structure (31) is provided on the slotted guide structure (31) said holding structure being configured in such a way that, as a result of an effect of the holding structure (40), the actuating rod (41) maintains a position substantially maximally disengaged in relation to the clutch actuator (14).

2. The actuation device according to claim 1, wherein the actuating rod (41) is elastically preloaded in a direction towards the slotted guide structure (31) and the slotted guide structure (31) is configured in such a way that a restoring force due to the holding structure (40) is exerted by the actuating rod (41) on the actuating disc (31) such that, in order to rotate the actuating disc (55) oppositely to the actuating direction of rotation (39), a force must be exerted at least temporarily by the electric motor (11) on the actuating disc (31) in a direction opposite to the actuating direction of rotation (39).

3. The actuation device according to claim 1, wherein the holding structure is configured as a local recess (40) in the slotted guide structure (31).

4. The actuation device according to claim 3, wherein the recess (40) is configured in such a way that the radius (r) decreases from a point at a beginning (42) of the recess (40) in the actuating direction of rotation (39) about the axis (65) in a direction towards a center (44) of the recess (40).

5. The actuation device according to claim 1, wherein the holding structure is configured as a region having a constant radius (4).

6. The actuation device according to claim 1, wherein the holding structure is configured as a planar, straight surface of the slotted guide structure (31) wherein the actuating rod (41) is displaced axially in relation to the axis (65) beyond the maximum radius point (37) with one further rotation of the actuating disc (55).

7. The actuation device according to claim 1, wherein the actuating rod (41) is supported on the slotted guide structure (31) by a bearing (47) mounted to said actuating rod.

8. The actuation device according to claim 1, wherein a worm (59) is disposed on a shaft (57) of the electric motor (11) and wherein the actuating disc (55) is configured as a worm wheel (61), teeth (56) of which engage with the worm (59).

9. The actuation device according to claim 1, wherein the actuating disc (55) is configured as one piece with the slotted guide structure (31).

10. The actuation device according to claim 1, wherein a shaft (57) of the electric motor (11) and the actuating rod (41) are disposed at an oblique angle to one another.

11. An electrically actuatable clutch system (1), comprising an actuation device (13) for actuating a hydraulic clutch actuator (14) according to claim 1.

12. The actuation device (13) according to claim 1 wherein a radius (r) of the contact surface (33) increases continuously in relation to the axis (65) from the minimum radius point (35) in the actuating direction of rotation (39) about the axis (65) to the maximum radius point (37), and wherein the holding structure (31) is provided on the slotted guide structure (31) in close proximity to the maximum radius point (37).

13. The actuation device according to claim 1, wherein the holding structure is configured as a local recess (40) in the slotted guide structure (31) in close proximity to the maximum radius point (37).

14. The actuation device according to claim 1, wherein the holding structure is configured as a region having a constant radius (4) in which the actuating rod (41) is not axially displaced beyond the maximum radius point with one further rotation of the actuating disc (55).

15. The actuation device according to claim 1, wherein the holding structure is configured as a planar, straight surface of the guide structure (31) and as a peripheral surface of the actuating disc (55), wherein the actuating rod (41) is displaced axially in relation to the axis (65) beyond the maximum radius point (37) with one further rotation of the actuating disc (55).
